(19) United States
(12) Patent Application Publication
(10) Pub. No.: US 2008/0130305 A1
(43) Pub. Date: Jun. 5, 2008

(54) LED Lights for Interior Automotive Lighting

(75) Inventors: Jianhua Wang, Canton, MI (US); Daniel J. Wheeler, Clarkston, MI (US); George F. Lambert, Fenton, MI (US); Gregory J. Vargo, Troy, MI (US); Patricia A. Flores, Clawson, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/566,722

(22) Filed: Dec. 5, 2006

(51) Int. Cl. B60Q 3/02

(52) U.S. Cl. 362/492; 362/488

(57) ABSTRACT

An interior lighting arrangement for automotive use comprises an array of light emitting diodes (LEDs) encapsulated in a light diffusing material disposed in a frame with a lens overlying the light diffusing material, the array of LEDs and the frame. Preferably, the light diffusing material is translucent epoxy and the lens is grated to further diffuse and direct light. In accordance with one embodiment of the LED lighting arrangement, the lighting arrangement is in combination with a sun visor to illuminate a vanity mirror.

### FIELD OF THE INVENTION

The present invention relates to LED lights for interior automotive lighting. More particularly, the present invention relates to such lighting used for applications, such as, but not limited to, automotive sun visors.

### BACKGROUND OF THE INVENTION

Currently, lights that are used with sun visor vanities and for general interior lighting of motor vehicles tend to be incandescent lights. LED lights are increasingly used in luxury vehicles because of appearance, ability to control color and long bulb life. LEDs tend to be directional and are therefore difficult to use on items such as sun visors. Moreover, the use of optics alone to defuse the light from LEDs has had limited success. In addition to the aforementioned quality considerations, there are cost considerations, not only of manufacturing costs but also of maintenance costs.

### SUMMARY OF THE INVENTION

In view of the aforementioned considerations, an interior lighting arrangement for automotive use comprises an array of light emitting diodes (LEDs) encapsulated in a light diffusing material disposed in a frame with a lens overlying the light diffusing material, the array of LEDs and the frame.

In one aspect of the lighting arrangement, the light diffusing material is translucent epoxy.

In a further aspect of the lighting arrangement, the lens is configured as a light diffuser.

In a further aspect of the lighting arrangement, the frame is configured as an enclosure completely surrounding the epoxy except for a light emitting area, the light defusing lens being attached to the enclosure at a periphery of the box adjacent to the light emitting area.

In a further aspect of the lighting arrangement, the lighting arrangement is in combination with a sun visor.

In still a further aspect of the lighting arrangement, the interior lighting arrangement comprises an interior light mount configured as a sun visor on which at least one interior light is mounted. At least one frame is mounted on the sun visor, wherein the frame defines an enclosed space with a light emitting area facing away from the enclosed space and the sun visor. An array of light emitting diodes (LEDs) are disposed in the enclosed space. A light defusing material encapsulates the LEDs in the enclosed space; with a lens overlying the light defusing material, the array of LEDs and the light emitting area.

In still a further aspect of the lighting arrangement, the sun visor has a mirror disposed between a pair of LED lighting arrangements.

In still a further aspect of lighting arrangement, the LED lighting arrangements are recessed within depressions in the upper surface of the sun visor.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a perspective view of an LED lighting arrangement according to the present invention;

FIG. 2 is an elevation taken along lines 2-2 of FIG. 1;

FIG. 3 is a perspective view of the lighting arrangement of FIGS. 1 and 2 with the lens detached;

FIG. 4 is a planar view, partially in perspective, of the upper side of a sun visor used adjacent to a windshield of an automotive vehicle, wherein the sun visor is in combination with at least one array of LEDs to provide an LED lighting arrangement; and

FIG. 5 is a perspective view of another embodiment of the LED lighting arrangement.

### DETAILED DESCRIPTION OF THE PREFERRED EMBODIMENTS

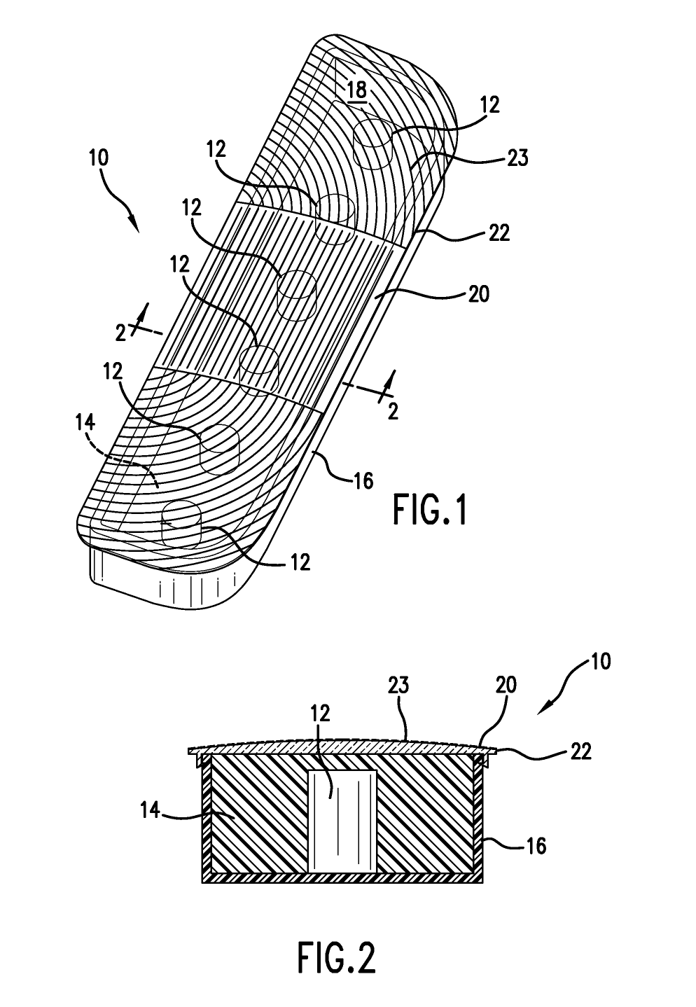

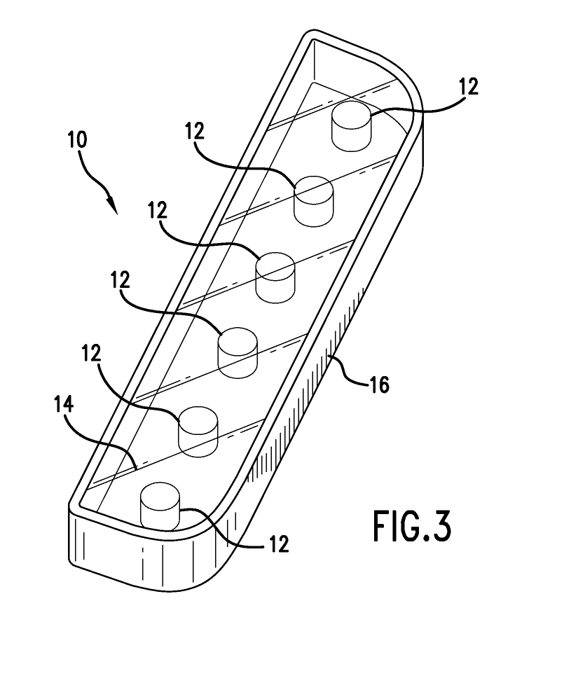

Referring now to FIGS. 1-3, there is shown an LED lighting arrangement 10 configured in accordance with the principles of the present invention, wherein an array 11 of LEDs 12 is encapsulated in a light diffusing material 14 such as transparent or translucent epoxy resin. The light diffusing material 14 is retained in a frame 16, which defines a light emitting area 18. The frame 16 has a peripheral edge 20 which supports a lens 22. Preferably, the epoxy resin 14 is translucent so as to diffuse light from the array 11 of LEDs 12, while the opaque frame 16 provides an enclosure that controls light from the LEDs, thus preventing undesired bleeding of light to other components or areas where the light is not desired. Preferably, the lens 22 has a grating 23 formed thereon which also diffuses and/or directs light from the array 11 of LEDs 12.

In accordance with other embodiments of the invention, the LEDs 12 may have colors other than white; for example, the LEDs may be red so that the illumination therefrom does not interfere with the driver's vision. The LEDs 12 also may be of various colors so as to tint or otherwise configure light emitted from the lighting arrangement 10. While the array 11 of LEDs 12 are shown in a straight line in FIG. 1, the array may assume other configurations, such as the configuration shown in the embodiment of the FIG. 5. Moreover, while they embodiment of FIG. 1 shows six LEDs 12, the number of LEDs may vary to suit the purpose of the lighting arrangement 10.

While epoxy resin 14 is preferred, other translucent material may be used to defuse the light from the LEDs 12. When epoxy resin 14 is used, the transparency of the epoxy resin may be adjusted to provide the desired diffusion of the LEDs 12.

While it is preferable that the lens 22 further diffuse, or otherwise enhance, the characteristics of light passing from the array 11 of LEDs 12 and through the encapsulating layer 14, the lens can be transparent, translucent, curved or planar and can have diffusion and/or directional grating 23 thereon.

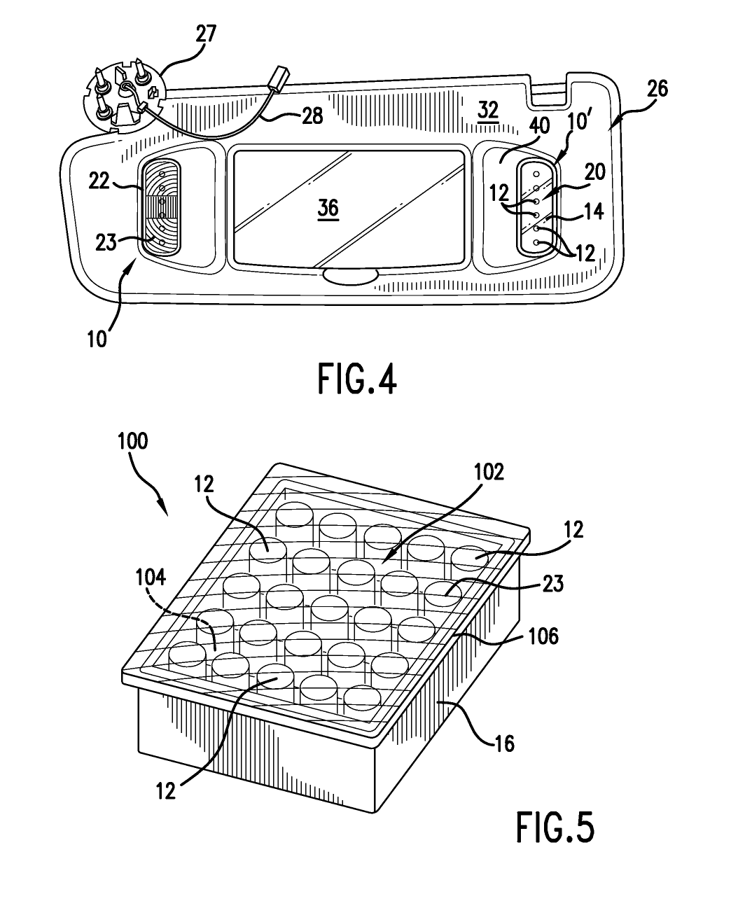

By configuring LED lighting arrangements 10 as shown in FIGS. 1-3, LEDs 12 are made suitable for general lighting and for applications such as vanity lights as shown in FIG. 4. Previously, LEDs 12 found use as directional lighting used for background lighting and reading lamps.

Referring now to FIG. 4, the aforedescribed lighting arrangement 10 of FIGS. 1-3 is shown in combination with a sun visor 26, which is mounted by a hinge 27 so as to be flipped up to face the roof (not shown) of the automotive vehicle. The lighting arrangements 10 or 10′ are connected by a cable 28 to a source of DC current. The sun visor 26 has an upper surface 32, which is normally not seen when the sun visor is pivoted to a position where the upper surface 32 faces the roof of the vehicle (not shown). In the illustrated embodiment, the upper surface 32 of the sun visor 26 includes a mirror 36 flanked by a pair of LED lighting arrangements 10. Preferably, the lighting arrangements 10 are identical to one another and are rotated 180° so as to be mirror images of one another. The lighting arrangements 10 are shown seated in indentations 38 and 40. In the illustration, the LED lighting arrangement 10 in the indentation 38 on the left side of the mirror 36 has a lens 22 which is configured with a grating 23 to further the diffuse LED light with lines 41 and to direct light with lines 42 from the array 11 of LEDs 12. The lighting arrangement 10′ in an indentation 40 is shown without a lens 22. This is because in this embodiment the epoxy 14 of the lighting arrangement has light diffusing material 14, which is configured to both diffuse and direct light from the LEDs 12. Preferably, when used on a sun visor 26 the LED lighting arrangements 10 and 10′ are identical, both including or both not including the lens 22.

Referring now to FIG. 5 wherein another embodiment 10 of the LED lighting arrangement is shown, the lighting arrangement is rectangular in configuration and has an array 102 of twenty-five LEDs 12 encapsulated in a material 104. The lighting arrangement 100 preferably includes a lens 106 mounted on a frame 108 that contains the material 104 and array 102 of LEDs 12. The embodiment 100 has use as a cabin light in an automotive vehicle but may have other uses.

As indicated by comparison of the configurations of FIGS. 1-4 with FIG. 5, the LED lighting arrangement may have any geometric configuration or number of LEDs 12 to provide interior lighting suitable for the purpose intended, such as light sources for vanity mirrors, ceiling lights, door lights or any other interior light.

LED lighting arrangements have a long life at least ten times that of traditional incandescent lights while consuming less power, heat and space. Moreover, light from LED lighting is available in all colors and when configured according to the present invention distributes light more evenly. LED lighting arrangements allow increased flexibility in designing vehicle lighting packages. For example, smaller lamp packages more suitable for confined areas are possible using LED lighting arrangements.

From the foregoing description, one skilled in the art can easily ascertain the essential characteristics of this invention, and without departing form the spirit and scope thereof, can make various changes and modifications of the invention to adapt it to various usages and conditions.

We claim:

1. An interior lighting arrangement for automotive use comprising:
a frame defining an enclosed space and a light emitting area;
an array of light emitting diodes (LEDs) disposed in the enclosed space;
a light diffusing material encapsulating the LEDs in the enclosed space, and
a lens overlying the light diffusing material, LEDs and light emitting area defined by the frame.

2. The interior lighting arrangement of claim 1 wherein the light diffusing material is translucent epoxy.

3. The interior lighting arrangement of claim 2 wherein the lenses are configured as a light diffuser.

4. The interior lighting arrangement of claim 3 wherein the frame is configured as an enclosure which completely surrounds the epoxy except for the light emitting area, the light diffusing lens being attached to the enclosure at a periphery of the enclosure adjacent to the light emitting area.

5. The interior lighting arrangement of claim 4 in combination with a sun visor.

6. An interior lighting arrangement for automotive use comprising:
an interior light mount configured as a sun visor on which at least one interior light is mounted; at least one frame on the sun visor; the frame defining an enclosed space and a light emitting area facing away from the enclosed space and the sun visor;
an array of light emitting diodes (LEDs) disposed in the enclosed space;
a light defusing material encapsulating the LEDs in the enclosed space, and
a lens overlying the light defusing material, LEDs and light transmitting area.

7. The interior lighting arrangement of claim 6 wherein the light defusing material is translucent epoxy.

8. The interior lighting arrangement of claim 7 wherein the lens is configured as a light diffuser.

9. The interior lighting arrangement of claim 8 wherein the frame is configured as an enclosure which completely surrounds the epoxy except for the light emitting area, the light diffusing lens being attached to the enclosure at a periphery of the enclosure adjacent to the light emitting area.

10. The interior lighting arrangement of claim 9 wherein there are at least two frames on the sun visor, each frame having the array of LEDs and light defusing material therein and having the lens thereon.

11. The lighting arrangement of claim 11 wherein the sun visor has a mirror disposed between the pairs of lights.

12. The lighting arrangement of claim 11 wherein the lights are recessed within depressions in the upper surface of the sun visor.
